(19) United States
(12) Patent Application Publication
(10) Pub. No.: US 2010/0021690 A1
(43) Pub. Date: Jan. 28, 2010

(54) Protective Pad and Method for Manufacturing Foam Structures with Uniform Pegs and Voids

(76) Inventor: Kevin McCarthy, Sammamish, WA (US)

Correspondence Address: DEAN A. CRAINE, 9-Lake Bellevue Drive, Suite 208, BELLEVUE, WA, 98005, US

(21) Appl. No.: 12/510,241

(22) Filed: Jul. 27, 2009

Related U.S. Application Data
(60) Provisional application No. 61/137,052, filed on Jul. 25, 2008.

(51) Int. Cl. B32B 3/10

(52) U.S. Cl. 428/158; 264/41

(57) ABSTRACT

An improved, impact energy dissipating foam pad and method for creating a foam pad that includes plurality of uniform pegs and holes in a closed cell foam substrate. A foam substrate plank is placed between two compression molds that includes a plurality of perpendicularly aligned pegs formed thereon. The compression mold's pins have sufficient length and are offset so that when the two compression molds are pressed together, the tips of the pegs on one compression mold penetrate the area located between two pins on the opposite compression mold. The compression molds are then pressed into the heated substrate plank. The two compression molds are then removed and the compressed substrate plank is allowed to cool causing the closed voids to be ‘set’. After cooling, the compressed substrate plank is then cut transversely along a line parallel to the plank's top and bottom surfaces and perpendicular to the closed voids. The two half foam substrates formed after cutting are then re-heated which causes the compressed voids to expand to their original size thereby forming two half foam substrates with alternating, uniform pegs and holes.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

This utility patent application is based on and claims the priority filing date of the U.S. provisional patent application (Ser. No. 61/137,052) filed on Jul. 25, 2008.

### BACKGROUND OF THE INVENTION

1. Field of the Invention

This invention pertains to molds and methods used to manufacture foam structures, and more particularly for methods used to manufacture uniform pegs and voids, and high and low elevations in foam structures.

2. Description of the Related Art

Today, a large variety of structures, such as seating components, footwear, sports equipment handles, protective padding, and head gear, are made of closed cell foams. These closed cell foams are typically vinyl, ethylene, olefin, styrene, polyester, nitrile, or a composite blend of these and other compounds. These closed cell foams are uniquely moldable when exposed to higher controlled heat and then pressed into shape. The main advantage of closed cell foam is that it is shock absorptive, compression and water resistance. It is also lightweight, inexpensive and highly durable. Recent studies have shown that structures made of closed cell foam with pegs and holes are more protective than structures made of open cell foam or structures made of closed cell foam without pegs and holes because they decelerate impacts and have greater load transfer qualities.

Recently, scientific studies show that lighter weight foams, those with densities between 1 and 8 lbs per cubic foot, and those lighter weight foams having a stiffer durometer, those with a 20 to 90 shore A scale, have the greatest effect in “decelerating” load impact and henceforth protecting the human body. These lighter weight, homogenous foams, (under 8 lbs. per cubic foot in density) are only manufactured in sheet or plank form, and not manufactured in injection molding methods. Injection foam molding is limited to densities of 8 lbs per cubic foot and greater, and therefore cannot be molded to create lower densities, because the processing damages the foam when it is formulated to expand more. Injection bead foam, another foaming process used in helmets and coffee cups, is moldable at lower densities but does not have the same durable physical properties as sheet foam processing, nor can it be molded or converted in convoluted or integral layers. It is the scope of this invention to “convert” lower density sheet and plank foams between the densities of 1 and 12 lb. per cubic foot, and to specifically utilize the averaged densities between 1 and 8 lbs per cubic foot, for the purposes of decelerating and transferring load impacts, in protective gear, seating and cushioning.

Today, die-cutting is the main process used to form large numbers of uniform holes in a closed cell foam structure. Unfortunately, the die-cutting process requires special cutting tools, and is very labor intensive. Also, it produces a relatively a large amount of waste material (i.e. cut material) that is must be discarded. Because the die-cutting process is relatively expensive do to material wasted, it is primary used with foam products where uniform holes in the foam product are required for ventilation. However, there currently is no method for converting foam sheet into a matrix of holes and standing support columns without great expense and wasted material. The featured matrix of holes and columns in fabricated foam sheet proves highly beneficial in the deceleration and transference of impact loads onto a closed-cell foam sheet or plank.

### SUMMARY OF THE INVENTION

It is an object of the present invention to provide a protective pad with improved impact energy dissipating properties.

It is an object of this invention to “convert” lower density sheet and plank foams between the densities of 1 and 12 lbs. per cubic foot.

It is an object method for creating close cell foam products with surfaces having a plurality of alternating, uniform pegs and holes formed therein.

It is another object of the present invention to provide a method of manufacturing closed cell foam products with uniform pegs and holes that is less expensive and produces less waste than molding and die-cutting processes.

It is another object of the present invention to provide a method of manufacturing closed cell foam products with uniform pegs and holes on one surface or multiple surfaces.

It is further object of the present invention to provide a method of manufacturing that enables the manufacturer to easily adjust the spacing, height and depth of the pegs and voids on the foam structure to achieve different breathability, impact deceleration and load transference qualities.

These and other objects are met by the improved protective pad made of low density, converted, closed cell thermoplastic foam with uniformly created pegs and voids formed in its lower surface which is placed against the surface to be protected against impacts. A method is also disclosed for manufacturing the pad that uses two parallel compression molds, placed between two platens on a compression molding machine. Compression molding, also known as thermoforming, is used to form thermoplastic sheet foam. Each compression mold includes a flat plate body with a plurality of perpendicularly aligned pins on its working surface. In the preferred embodiment, the pins have uniform lengths and diameters and are evenly spaced apart over the plate body. However, customized product can be produced by varying the location and heights of the pins. The pattern of metal pins on the two plate bodies are offset so that when the two compression molds are pressed together on opposite sides of a heated, planar foam substrate plank, the tips of each pin on one compression mold penetrate the area located between two pins on the opposite compression mold. Also, the thickness of the foam substrate plank and the length of the pins are sufficient so that the pins on each compression mold extend at least slightly beyond the tips of the pins on the opposite compression mold. In the preferred embodiment, the pins have sufficient length and sufficient pressure is applied to the compression molds so that the pins extend between 51% to 90% the thickness of the foam substrate plank.

A foam substrate plank with parallel, flat top and bottom surfaces, is placed between the two compression molds. The foam substrate plank is then heated and the two compression molds are then pressed into the top and bottom surfaces. A plurality of parallel, offset, uniformly spaced apart, closed deep voids are formed on opposite sides of the foam substrate plank. After the foam is allowed to cool within the mold, the two sides of the compression molds are then removed and the foam substrate plank is left with the closed voids ‘set’ in the foam substrate plank. The foam substrate plank is then cut transversely along a line parallel to the plank's top and bottom flat surfaces and perpendicular to the closed voids. In the preferred embodiment, the substrate plank is cut along a line that divides the area in the foam substrate where the tips of the closed voids that extend from the opposite surfaces overlap. In the preferred embodiment, the pins on the compression molds are uniformly spaced apart and have the same pattern of lengths, so that when the foam substrate plank is cut along its midline axis, two equal size half foam substrates each being the mirror image of each other with uniform voids formed therein. One or both half foam substrates are then re-heated which causes the compressed voids formed therein to expand to their original size thereby forming one or two half foam substrates with alternating, uniform pegs and holes formed therein.

The above described process offers several advantages. First, it produces foam substrates with a large number of alternating, uniform pegs and holes that cannot be manufactured using conventional molding processes. Because all of the foam substrate is used, little or no waste material is generated. Also, because the half foam substrates are reheated, they return to their ‘relaxed’ state and are thereafter, ‘heat stable’.

It should be noted that the overall thickness of the final half foam substrate is equal to the sum of the thickness of the non-penetrated section of the foam section plus the depth of the voids created by the pins. By using different compression molds with different lengths of pins and applying different amounts of pressure on the two compression molds, the overall thickness of each one-half foam substrate can be easily adjusted.

When the large foam substrate is cut on its midline axis, two, equal size, half foam substrates are created. After reheating the two half foam substrates, they can be longitudinally aligned to form a large sheet of foam with uniform pegs and voids or stacked together to form foam structures with uniform pegs and voids on opposite surfaces. Examples of products that can be made using the above process include the following: contact sports padding, head gear, shoe insoles, mid-soles and liners, seat cushions and pads, flooring, bicycle seats, sports or yoga mats, children play surfaces, and the like.

### DESCRIPTION OF THE DRAWINGS

FIG. 1 is a side elevational view of protective pad with positioned on a surface to be protected against impact surfaces.

FIG. 2 is a side elevational view of the protective pad shown in FIG. 1 showing the movement of the pegs directly under and lateral from the point of impact.

FIG. 3 is a side elevational view of a protective pad with an upper layer attached over the foam substrate

FIG. 4 is a side elevational view of the protective pad shown in FIG. 3 showing the movement of the pegs located directly under and laterally from point of impact.

FIG. 5 is a sectional side elevational view of a foam substrate with an upper and an lower film or cover layer.

FIG. 6 is a sectional side elevational view of two half substrates with one film or cover layer formed on the side opposite the pegs and voids.

FIG. 7 is an illustration of a thick, rectangular shaped substrate plank made of thermo-set plastic foam heated to a malleable state and then placed between and upper and lower platen each with a plurality of pegs formed thereon.

FIG. 8 is a sectional, side elevational view of the foam substrate plank placed between the two platens as shown in FIG. 7.

FIG. 9 is a sectional, side elevational view of the foam substrate plank showing compression voids formed on its top and bottom surfaces.

FIG. 10 is an illustration showing the substrate plank with compression voids formed on one side that bypass staggered compress voids formed on the opposite side.

FIG. 11 is a perspective view showing the substrate plank cut along its midline axis to form two equal size two half substrates.

FIG. 12 is a perspective view of two half substrates being re-heated thereby allowing the compress and stretch material to relax and return to its original shape.

FIG. 13 is a perspective view of one-half substrate in a relaxed, final state.

FIG. 14 is a perspective view of substrate half with a film or fabric layer placed over the top surface of the pegs.

FIG. 15 depicts the steps used to manufacture the protected pad with a plurality of uniform pegs and voids using compressing molding on thermoplastic, closed cell foam.

### DETAILED DESCRIPTION OF THE PREFERRED EMBODIMENT(S)

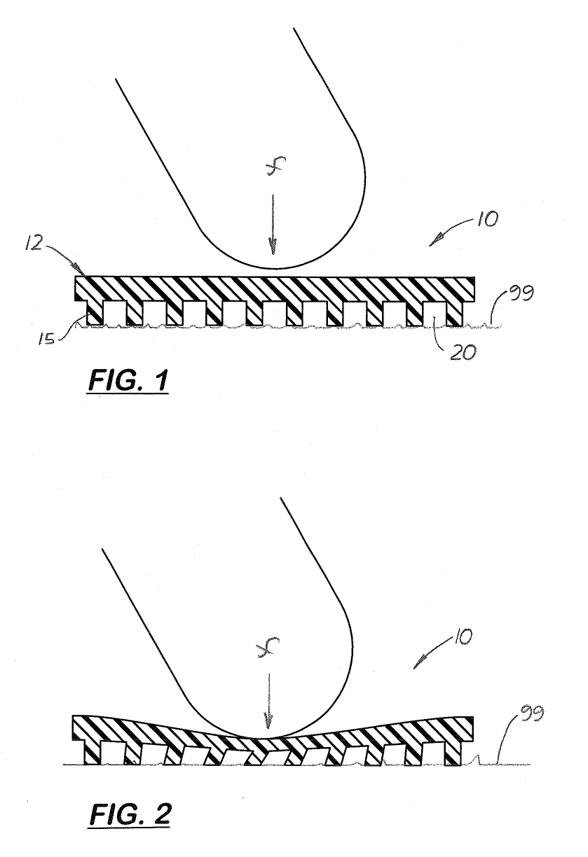

Referring to FIGS. 1-4 a protective pad 10 made of low density, converted, closed cell cross-linked plastic foam substrate 12, with a plurality of integrally formed, downward extending pegs 15. The pegs 15 are uniform in size and shape and are evening spaced apart by voids 20. In FIG. 1 is a side elevational view of the protective pad 10 positioned on a surface 99 with the pegs 15 pointed downward. FIG. 2 is a side elevational view of the protective pad 10 shown in FIG. 1 showing the bending movement of the pegs 15 directly under and lateral from the point of impact force (f) thereby dissipating energy.

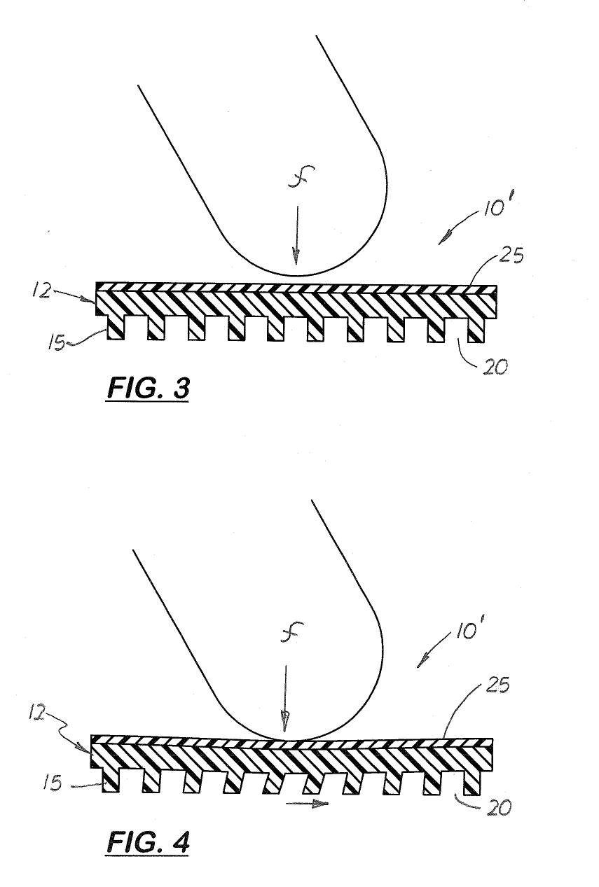

FIGS. 3 and 4 are illustrations similar to the illustrations shown in FIGS. 1 and 2 showing a flexible or semi-rigid upper layer 25 attached or formed over the top surface of the foam substrate 12 and used to further dissipates impact force (f) energy over the protective pad 10′.

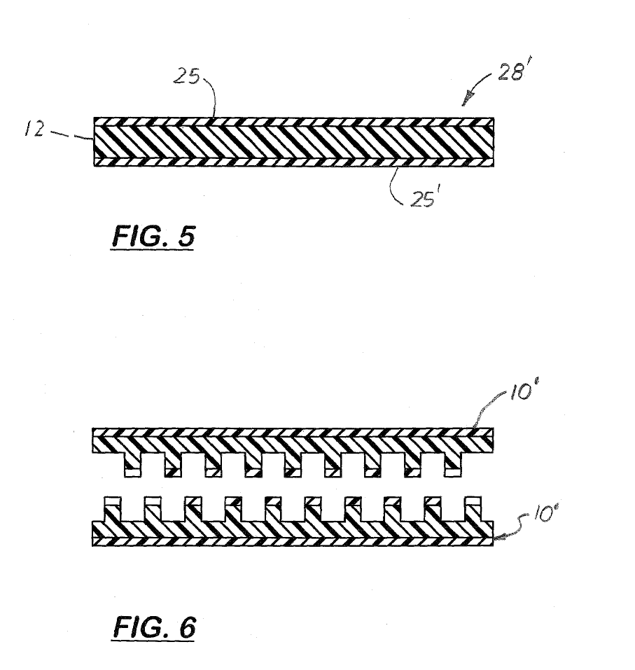

FIG. 5 is a sectional side elevational views of a foam substrate plank 12 with two flexible or semi-rigid layers 25, 25′ attached or formed on the opposite sides which is then molded into two pads 10, 10′ each with one flexible or semi-rigid layer 25, 25′ attached or formed on one surface (shown more clearly in FIG. 6).

The protective pad 10 is manufactured using a novel method that uses converted, closed cell, thermoplastic or cross-linked sheet of foam substrate plank 12. The method is specifically used to produce such closed cell foam products that are less expensive, less wasteful and allows the height and depth of the pegs and holes to be easily adjusted for different applications. The method is adaptable so that substantially the entire original foam substrate plank 26 may be used to form two nearly identical half foam size substrate pieces 30, 35. The two half foam substrates 30, 35 may then be used to assemble one final structure as shown in FIGS. 1, 3 and 6.

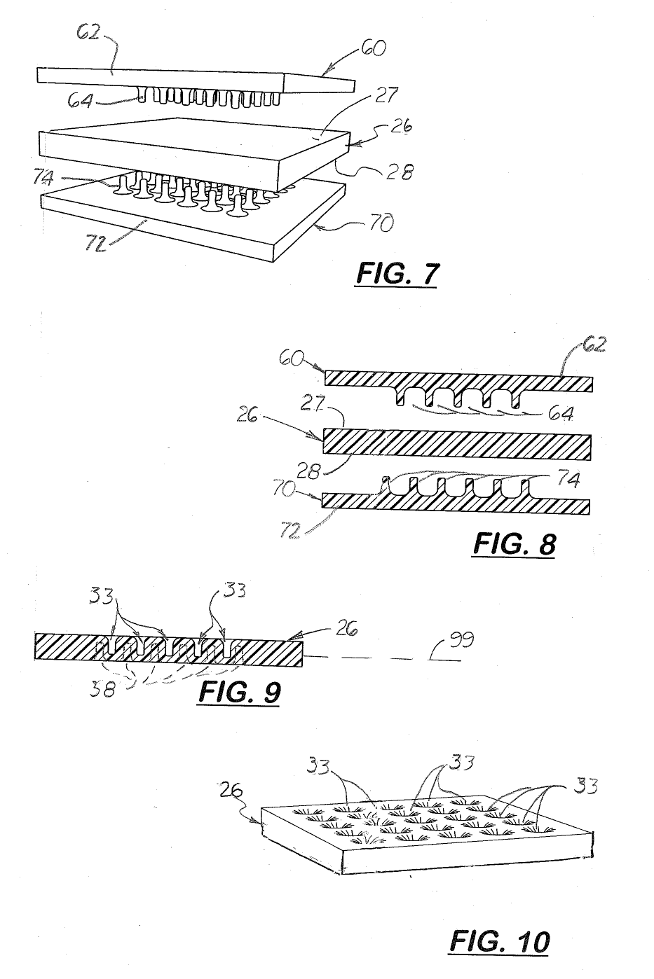

The method uses two parallel compression molds 60, 70 placed between two platens (not shown) on a compression molding machine (not shown). Each compression mold 60, 70 includes a flat plate body 62, 72 with a plurality of perpendicularly aligned pins 64, 74, respectively. FIG. 7 is an illustration of a closed cell substrate plank 26 with two molds 60,70 each with a plurality of uniform, staggered pins 64, 74, respectively, formed thereon being positioned on opposite sides 27, 28 of the foam substrate plank 26.

In the preferred embodiment, the pins 64, 74 have uniform lengths and diameters and are evenly spaced apart over the plate body, 62, 72, respectively. The pins 64, 74 on the two plate bodies 62, 72, respectively, are offset so that when the two compression molds 60, 70 are pressed together on opposite sides of a heated, planar foam substrate plank, the tips of each pin 64 or 74 on one compression mold 60 or 70, penetrate the area located between two pins 64 or 74 on the opposite compression mold 60 or 70 as shown in FIGS. 8 and 9. Also, the thickness of the foam substrate plank 26 and the length of the pins are sufficient so that the pins 64, 74 on each compression mold 60, 70, respectively, extend at least slightly beyond the tips of the pins 64, 74 on the opposite compression mold. In the preferred embodiment, the pin 64 74 have sufficient length and sufficient pressure is applied to the compression molds 60, 70, respectively, so that the pins 64, 74 extend between 51% to 90% the thickness of the foam substrate plank 26.

The foam substrate plank 26 is first heated to make it malleable and soft. The cold metal molds 60, 70 are then pressed against the two sides of the foam substrate plank 26. The pins 64, 74 on the two molds 60, 70, respectively, are staggered, therefore compressing the top and bottom surfaces 22, 24 underneath the pins 64, 74, as shown in FIG. 6. Compression voids 33, 38 are then formed on the two surfaces as shown in FIGS. 9-11′.

In the preferred embodiment, the pins 64 from one side of a mold 60 bypassing the staggered pins 74 from the other side of the mold 70, thereby creating a foam substrate plank 26 with a plurality of uniform compression voids 33, 38 formed of both sides that extend slightly beyond the midline axis 99.

FIG. 10 is a perspective view showing the foam substrate plank 26 molded on its opposite surfaces. The molds 60, 70 absorbs the heat of the low density foam quickly, returning the foam substrate plank 26 to room temperature and “freezing” (holding) the compressed position of the substrate plank 26 into a temporary state of fixed tension. The molds 60, 70 are then removed from the foam substrate plank 26 and the compressed voids 33, 37 are maintained in the compressed state as long as the temperature of the foam substrate plank 26 is not elevated.

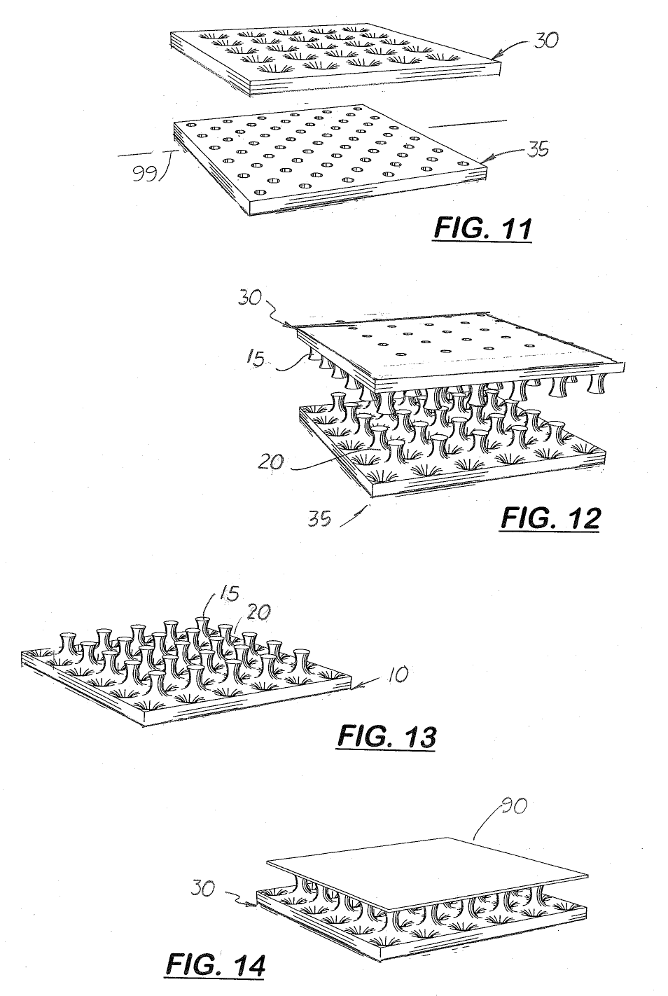

FIG. 11 is a perspective view of two substrate halves 30, 35 formed by cutting the foam substrate 26 cut along its midline axis 99 to form two equal one half foam substrates 30, 35.

FIG. 12 shows two half foam substrates 30, 35 with the compressed and stretched material being relaxed and returned to its original shape to form a plurality of uniform pegs 15 and voids 20 on one surface. In the first embodiment, the two half substrates 30, 35 are the same thickness. The cut extends through the voids 33, 37 extending from the opposite surfaces of the plank 26.

FIG. 13 is a perspective view of one substrate half 30 in a relaxed state with pegs 15 and voids 20 formed therein as shown in FIGS. 1-6. The pegs 15 and voids 20 have increased ability to transmit and transfer energy from indirect and direct linear and non-linear impacts, as compared with conventional foam substrates.

FIG. 14 is a perspective view of substrate half 30 with a film or fabric layer 90 placed over the top surface of the pegs 82. The substrate half 30 is then reintroduced to heat by placing it into a convection oven. The compressed surfaces and volumetric area of the substrates 30 relaxes under heat and returns to its original cross-linked thermo-set position. In doing so, the “stretched” surfaces of which were cut through, return to original position, and the “compressed” also returns to original height. The resulting geometry is of alternating pegs 82 and voids 84 in pattern of mirror image on each of the two equal split substrates 30, 35, with no waste of material.

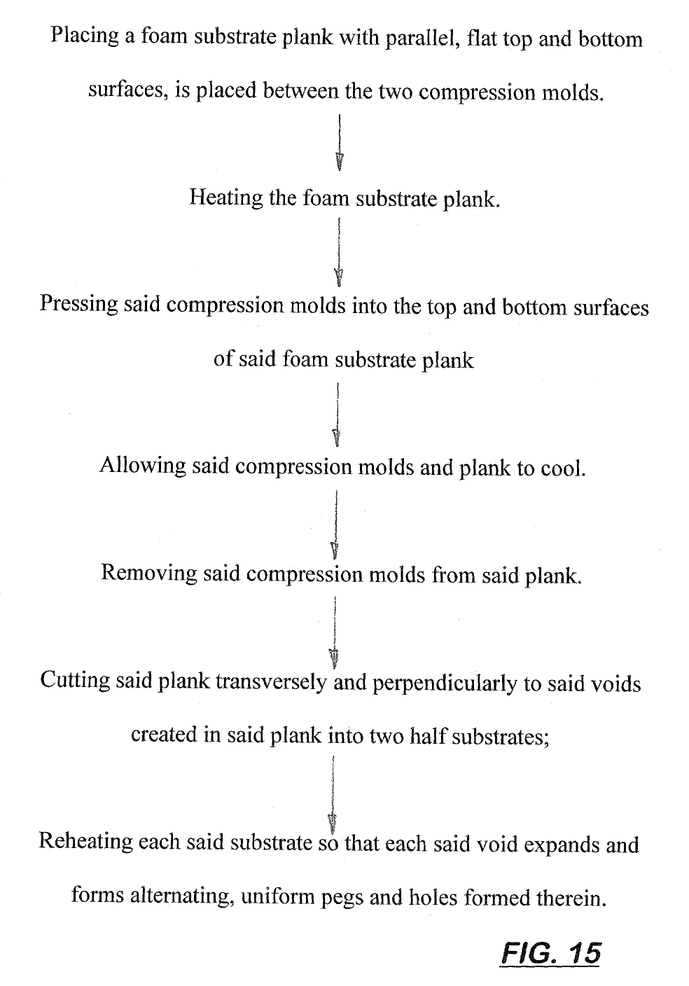

In summary, the method includes the following steps depicted in FIG. 15:

A foam substrate plank with parallel, flat top and bottom surfaces, is placed between the two compression molds. The foam substrate plank is then heated and the two compression molds are then pressed into the top and bottom surfaces. A plurality of parallel, offset, uniformly spaced apart, closed deep voids are formed on opposite sides of the foam substrate plank. After the foam is allowed to cool within the mold, the two sides of the compression molds are then removed and the foam substrate plank is left with the closed voids ‘set’ in the foam substrate plank. The foam substrate plank is then cut transversely along a line parallel to the plank's top and bottom flat surfaces and perpendicular to the closed voids. In the preferred embodiment, the substrate plank is cut along a line that divides the area in the foam substrate where the tips of the closed voids that extend from the opposite surfaces overlap. In the preferred embodiment, the pins on the compression molds are uniformly spaced apart and have the same pattern of lengths, so that when the foam substrate plank is cut along its midline axis, two equal size half foam substrates each being the mirror image of each other with uniform voids formed therein. One or both half foam substrates are then re-heated which causes the compressed voids formed therein to expand to their original size thereby forming one or two half foam substrates with alternating, uniform pegs 15 and voids 20 formed therein.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. An impact dissipating protective pad, comprising:
a. substrate made of closed cell foam, said substrate includes a planar top surface with a plurality of integrally formed downward extending pegs, said pegs having the same size, shape and length and being uniformly spaced apart and separated by voids having the same size, shape and depths and uniformly spaced apart, and;.
b. an outer layer or two outer layers, both top and bottom, attached to said top surface.

2. The pad as recited in claim 1, wherein said outer layer is made of natural leather, synthetic leather or vinyl.

3. The pad as recited in claim 1, wherein said outer layer is made of fabric

4. Method for creating a plurality of uniform pegs and holes on a closed cell foam substrate, comprising the following steps:
a. selecting a closed cell foam substrate plank with parallel top and bottom planar surfaces, said foam substrate includes a mid-line axis parallel to said top and bottom planar surfaces;
b. selecting a two compression plates, each said compression plate includes a plate body with a plurality of perpendicularly aligned, space apart pins, each pin being sufficient in length to extend at least to the foam substrate's midline axis, said pins on said compression plates being offset so that when said compression molds are positioned on sad top and bottom surfaces and pressed together, the tips of the pegs on one compression mold penetrate the area located between two pins on the opposite compression mold;
c. positioning said compression plates over said top surface and said bottom surface;
d. heating said substrate blank a sufficient temperature for compression or thermoform molding;
e. pressing said compression mold plates into said top and bottom surfaces of said substrate plank so that said pins extend at least beyond said midline axis of said substrate plank;
f. allowing the molded plank to cool in the mold
g. removing said compression plates from said substrate plank;
h. cutting the substrate plank a line parallel to said top and bottom surfaces of said substrate plank and in the section within said substrate plank where the tips of said pegs overlap; and,
i. reheating each half substrate so that the compressed voids expand and returned to their original lengths.
